(19) United States
(12) Patent Application Publication
(10) Pub. No.: US 2005/0000884 A1
(43) Pub. Date: Jan. 6, 2005

(54) Suspension screen raking system

(76) Inventors: George Burgess, Auckland (NZ); Brian Burgess, Auckland (NZ)

Correspondence Address: YOUNG & THOMPSON, 745 SOUTH 23RD STREET, 2ND FLOOR, ARLINGTON, VA, 22202, US

(21) Appl. No.: 10/485,953

(22) PCT Filed: Aug. 7, 2002
(86) PCT No.: PCT/NZ02/00149

(30) Foreign Application Priority Data
Aug. 7, 2001 (NZ) 513379

(51) Int. Cl. B01D 21/02

(52) U.S. Cl. 210/413

(57) ABSTRACT

A screen raking system has a screen and a rake which is driven by a single hydraulic cylinder to move the rake up and down a length of a screen and also move the screening away from the screen, compress the screenings and move them through a waste pipe to an area remote from the screen for disposal.

### FIELD OF THE INVENTION

This invention relates to a suspension screen raking system, by which is meant a system for the removal of solids and/or floatables (referred to generally herein as solids) from a screen placed across a channel or pool having a liquid suspension of such solids. The suspension screen raking systems to which the invention relates include water screen raking systems such as those placed across a water channel, such as a sewerage or waste water treatment channel, or a channel supplying water to a turbine.

### BACKGROUND OF THE INVENTION

Suspension or water screen raking systems usually have screens composed of horizontally spaced upright bars which are placed across channels or across an entrance or exit to a pool or reservoir. The screens are usually placed at an angle to the vertical and are provided to act as a filter. It is well known that the screens become blocked due to suspended matter in the water, or other liquid which is being filtered, collecting across the bars and eventually providing a substantial impediment to liquid flow through the screen.

It is known to utilise a rake or brush having teeth or brush elements which interdigitate with the screen bars to lift solids collecting on the bars and thus prevent the screen becoming clogged. The rake usually lifts the solids to the top of the screen where they are tipped into a removal channel or otherwise disposed of.

Such rakes are usually driven by a motor through a system of gears or chains and sprockets. This is not an ideal arrangement. It is complex and prone to jamming and failure. The use of an hydraulic or pneumatic ram would be preferable.

Existing systems also have problems with transferring the captured solids (commonly referred to as “screenings”) to a position where they can be further processed. Usually, such further processing includes pressing the screenings to reduce bulk prior to transporting to a location where they can be disposed of. Existing designs for washing and reducing screenings are maintenance intensive with many moving parts. Others are limited by their ability to cope with the large rise and fall in liquid levels within the channel, that is, peak loadings or flows. The inability of prior art constructions to cope with the larger rises and falls in liquid levels can create further problems associated with head loss. It would therefore be desirable to have a system which is capable of drawing screenings together to reduce their bulk for disposal in a manner, which is simple, effective and substantially maintenance free.

There is a considerable requirement in the water supply and waste water disposal and treatment industries for the supply of small to medium screening systems such as those, which could al most, screen a flow of up to 1 or perhaps 2 cubic meters per second, and which are conveniently located in the water channel.

### OBJECT OF THE INVENTION

It is an object of the present invention to provide suspension screen raising systems or methods which will at least go some way toward overcoming disadvantages associated with the prior art, or which will alternatively at least provide the public with a useful choice.

An alternative object of the invention is to provide a racing system which is on one plane or axis with a single prime mover.

Another alternative object of the invention is to provide a raking system wherein a single prime mover rakes a screen and conveys screenings to a disposal point remote from the screen.

### SUMMARY OF THE INVENTION

Accordingly in one aspect the invention consists in a system for the removal of solids from a suspension in which the solids are provided, the system including
a screen having a plurality of apertures therein,
a rake provided on or adjacent to the screen,
driving means to cyclically drive the rake in two opposing directions relative to the screen to move solids captured on the screen toward one end of the screen.

Preferably the screen comprises a trough.

Preferably the flow of solids from the screen through to discharge is in substantially one direction or axis.

Preferably the driving means comprises a single prime mover.

Preferably the screen is concave.

In this documents reference to “concave” means that the screen has edges which are nearer 10 the direction from which the water or other suspension is flowing than a part of the screen between the edges. Therefore, the screen may be a “V” shape or a “U” shape in cross-section. It may also have a substantially flat mid section with vertical or angled sides.

Preferably the driving means moves the rake periodically back and forth along the screen.

Preferably the time taken for the rake to traverse the screen in a direction toward one end is longer than the time taken on the downward stroke is less than the time taken for the rake on the upward stroke,

Preferably the accumulator means comprises a transition, preferably a cone transition element through which the solids are compressed before reaching an outlet like for disposal.

Preferably the screen is substantially semi circular. Preferably the screen extends across approximately 60%-70% of the circumference or though an arc of approximately 210° to 260°.

Preferably the screen sits at an operating angle which is suited to the application requirement, and may for example be from 20 to 45 degrees from the horizontal.

Alternatively, the screen is substantially triangular in cross-section.

Alternatively, the screen is substantially square in cross-section.

Preferably the screen elements run longitudinally with slots which are kept clear by a rake positioned and installed having teeth radiating from a disk member. Preferably the slots are greater than or equal to 3 mm.

Preferably the screening elements have a profile comprising a vertical section with a small section al right angles thereto.

Preferably the screening elements have a profile corresponding to an inverted “L”. Alternatively, the screening elements in profile comprise a T-section or alternatively a Y-section or have a vertical section which tapers from a wide cross-section to a narrow cross-section towards the base thereof.

Alternatively, the screen comprises a perforated member.

Preferably the perforated member has tapered apertures.

Preferably rake guide slots are also provided.

Alternatively, the drive means comprises a worm drive or other speed reducer, for example a speed reducer operating through a rack and pinion arrangement.

Preferably a bin or collector is provided to collect the screenings discharged from the accumulator means.

Preferably a wedge means is provided for moving screenings to a discharge location.

Preferably a plough means is provided for moving screenings through the accumulator means.

Preferably the bin may be up to 6 metres from the screen and 2-3 metres above the screen.

In a further aspect the invention consists in apparatus for the removal of solids from a screen, the solids having been separated from a suspension by the screen, the apparatus including
a rake means to, in use, lie adjacent to or in contact with the screen,
a driving means for moving the take means relative to the screen to move solids collecting on the screen, in use, to one end of the screen, and
an accumulator means provided at one end of the screen, the accumulator means reducing in cross-sectional area with distance from the screen whereby solids delivered to the one end of the screen by the rake means are pressed into close proximity with each other.

In a further aspect the invention consists in a system for removal of solids from a liquid suspension in which the solids are provided, a system including
a screen comprising horizontally spaced bars,
a rake provided on or adjacent to the screen,
a driving means to move the rake relative to the screen to thereby rake solids captured on the screen toward one end of the screen the driving means comprising a hydraulic or pneumatic cylinder which directly drives the rake.

In a further aspect the invention consists in apparatus for removal of solids from a screen, the solids having been separated from a suspension by the screen, the apparatus including
a rake means to, in use, lie adjacent to or in contact with the screen
a driving means for moving the rake means relative to the screen to move solids collecting on the screen to one end of the screen, and
the rake means including retraction means whereby the rake means may be moved between an operative position for moving solids and an inoperative position whereby the rake means may be moved relative to the screen by retraction means without substantially moving solids on the screen.

### DRAWINGS AND DESCRIPTION

The invention will be described with reference to drawings appended hereto in which

FIG. 1 is a side elevation of screening apparatus according to the present invention,

FIG. 1a is a side elevation of a screw conveyor adapted to be fitted into the transition funnel and waste pipe of FIG. 1,

FIG. 2 is a partial plan view of the apparatus of FIG. 1,

FIG. 3 is an end elevation of the apparatus of FIG. 2 viewed from the direction of arrow A,

FIG. 4 is an end view of the apparatus of FIG. 2 when viewed from the direction of arrow B,

FIGS. 5A-5D show screen elements according to the invention in cross-section,

FIG. 6 is a side elevation of further screening apparatus according to the invention including a rake profile and baffle to assist clearance of the screen during the downward stroke,

FIG. 7 is a side elevation of further screening apparatus according to the invention including a retraction device for selectively retracting the rake teeth,

FIG. 8 is a plan view of the lower part of the screen showing the teeth in the extended position,

FIG. 9 is a plan view of the upper end of the screen showing the rake teeth in the retracted position,

FIG. 10 is an end elevation of the rake arrangement used in FIGS. 7 to 9,

FIG. 11 is a side elevation in cross-section of a helical flight similar to that described with reference to FIG. 1A, but in a trough discharge tube,

FIG. 12 is an end elevation of the apparatus shown in FIG. 11,

FIG. 13 is a side elevation of the apparatus of FIGS. 11 and 12 but further showing a drive arrangement for driving the helical flight and also showing the prime mover which drives the rake,

FIG. 14 is a side elevation in partial cross-section of another example of a rake system according to the invention,

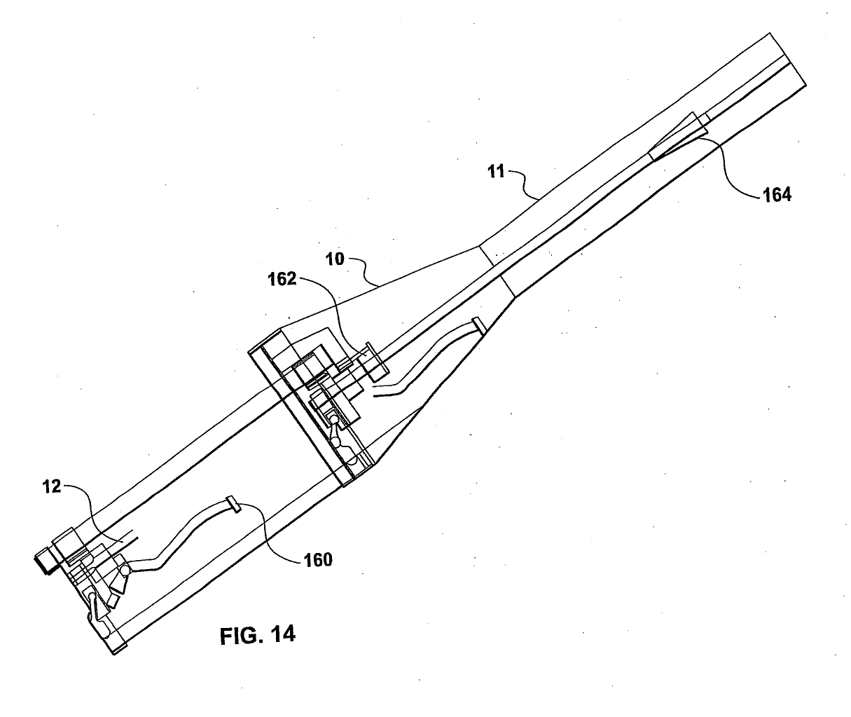

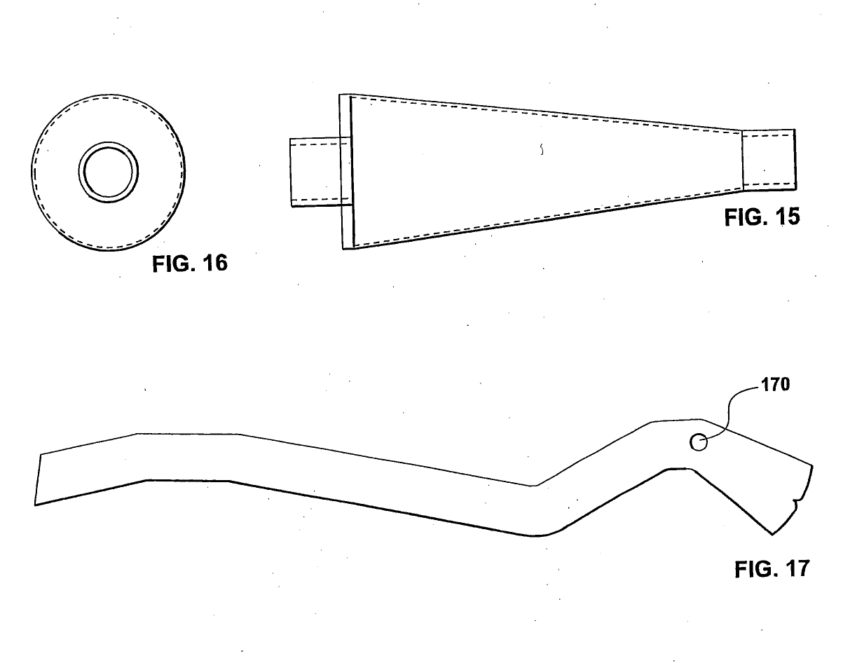

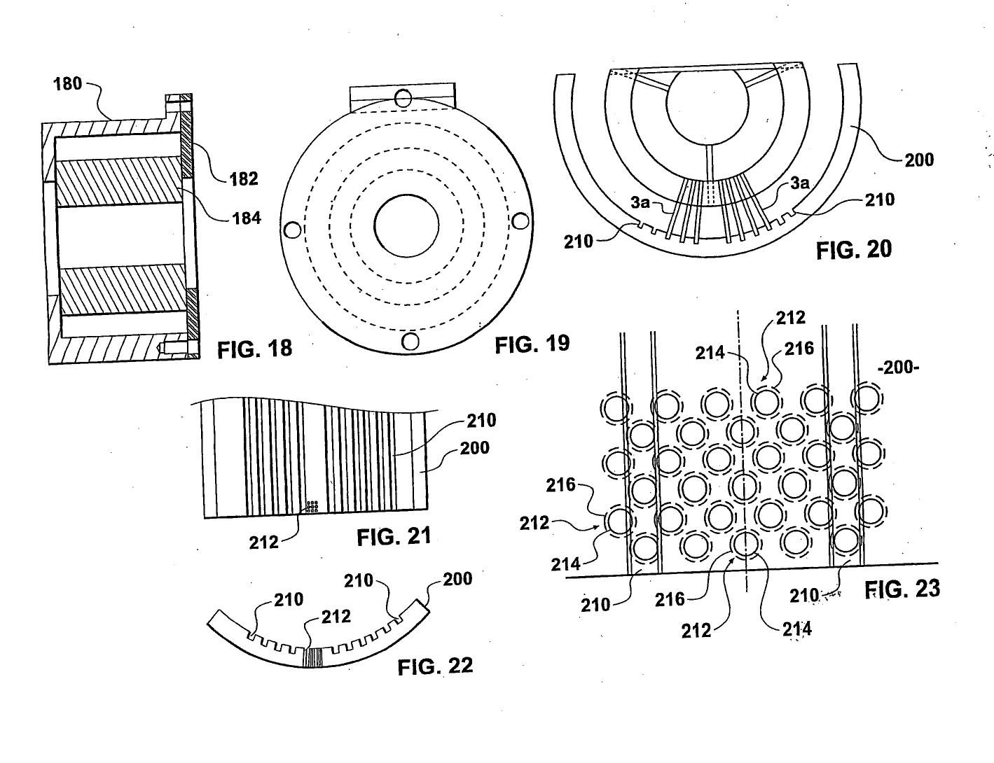

FIG. 13 is a side elevation of a wedge member used in the-construction of FIG. 14,

FIG. 16 is an end elevation of FIG. 15,

FIG. 17 is a side elevation of a plough member used in the construction of FIG. 14,

FIG. 18 is a side elevation in cross-section of a bearing used in the construction shown in FIG. 14,

FIG. 19 is a front elevation of FIG. 18,

FIG. 20 is an end elevation of the system of the present invention but with a perforated plastic screen,

FIG. 21 is a plan view of the screen of FIG. 20 shown holes therein,

FIG. 22 is a partial cross-section through A-A of FIG. 21, and

FIG. 23 is an expanded view of FIG. 20 showing holes in the screen in greater detail.

### DESCRIPTION OF PREFERRED EMBODIMENT

The following description is given by way of example and illustration only and shall not be used to limit the scope of the invention.

Reference will be made to the drawings, wherein like numerals designate corresponding parts throughout the several figures.

### EXAMPLE 1

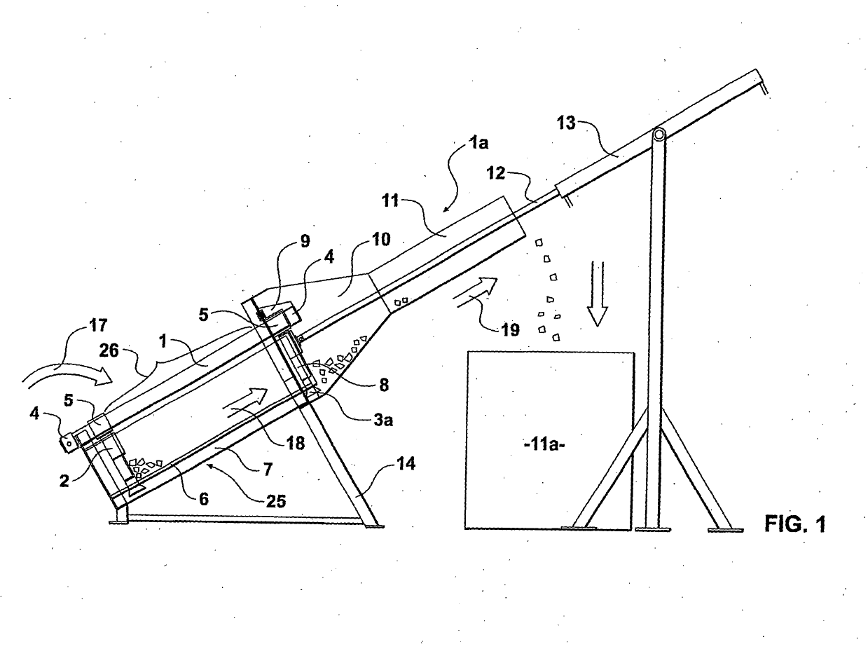

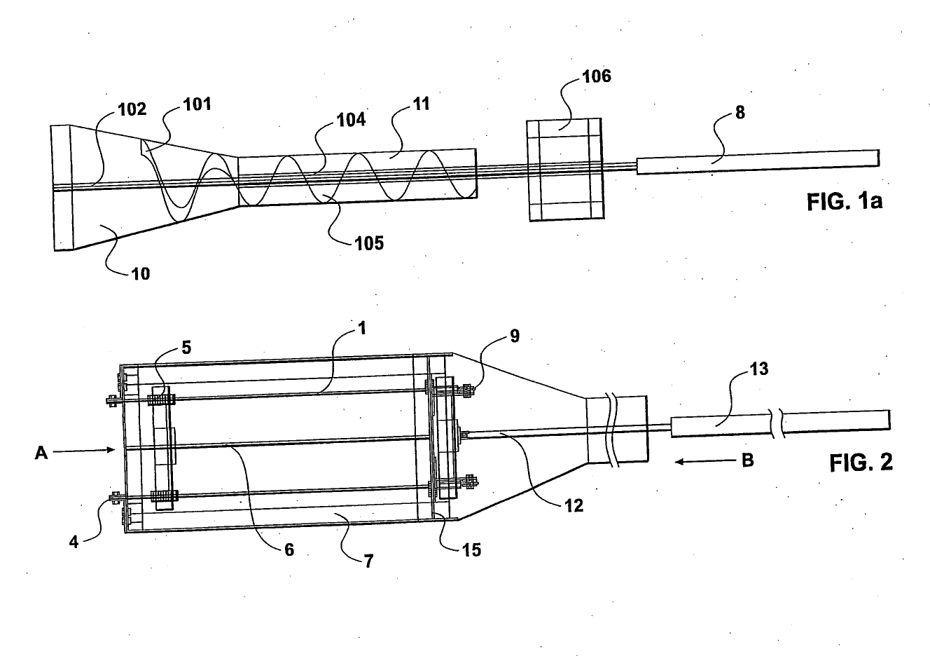

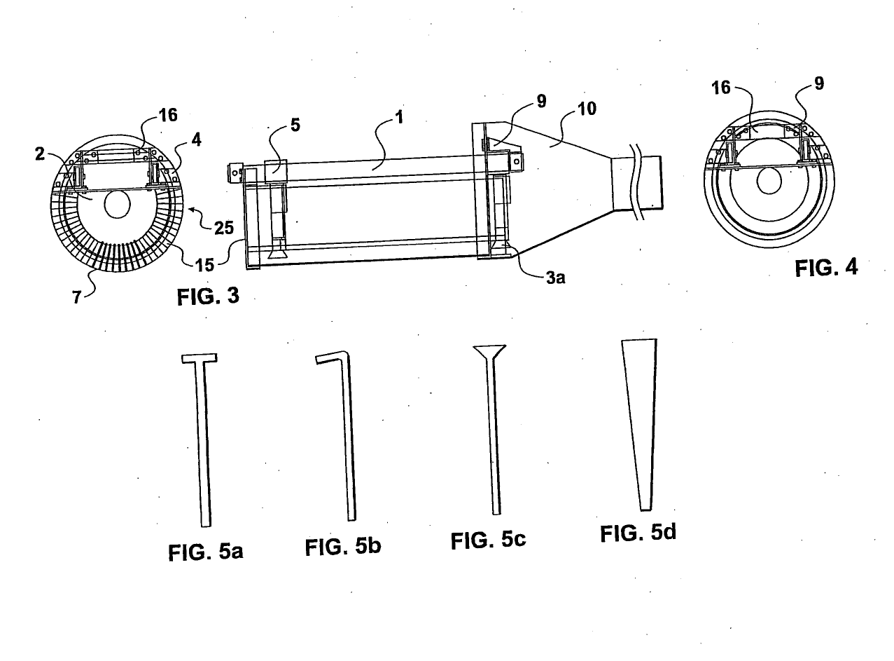

Referring to FIG. 1, the apparatus according to the present invention as shown generally referenced A. The apparatus has one or more (preferably two) guide rails 1 which in use support a rake 3 which is mounted on a disk 2. The disk 2, and rake tines/teeth 3 are illustrated more clearly with reference to FIG. 3. However, continuing to refer to FIG. 1, the rail 1 has an end guide brackets 4 thereon, which define the upper and lower positional limits or movement of the disk guide 5 which in use, slides upon guide rail 1 and supports the rake support disk 2. In FIG. 1, the rake 3 is shown in two positions, an upper position referenced 8, and a lower position near the lower end of the guide rail. The two extreme positions of the rake movement are shown for illustrative purposes only, there being only one rake disposed on the guide rails 1 in use. A centre guide 6 is also provided for the rake and prevents any substantial transverse movement of the rake tines or teeth, but allows longitudinal movement of the rake 3 in a motion parallel to the disposition of the guide rails 1.

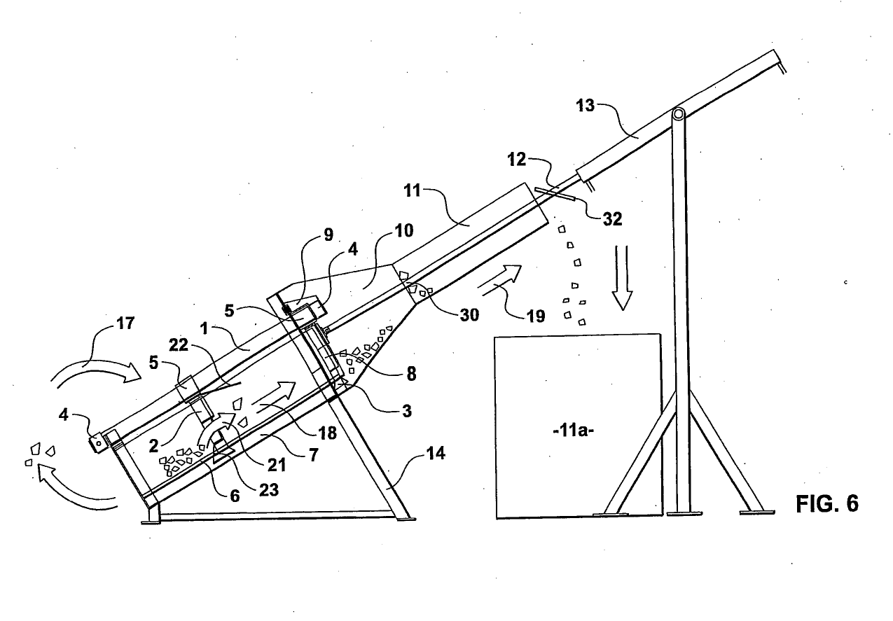

The screen elements 7 are longitudinal elements which, when assembled parallel to each other, as shown in the drawings, effectively create the screen which is generally referenced 25. FIG. 1 shows only one screen element 7 for clarity. For the purposes of the present example, in which a device for relatively low flow rates (in the order of 1 or 2 cubic metres per second) is described, the gap between adjacent longitudinal screen 25 elements is preferably 3 mm or more. The longitudinal elements may be a variety of shapes, but preferred shapes are illustrated and described further below with reference to FIGS. 5A to 5D. The screen, and preferably, but not necessarily, the apparatus that drives the rake are provided at an operating angle suited to, the application requirement, which will usually be between 25 to 45 degrees to the channel invert i.e. usually 25 to 45 degrees to the horizontal. The screen elements are preferably made from steel, but those skilled in the art will appreciate that suitable plastic materials such as polypropylene could alternatively be used. In particular, the screen may comprise a perforated plastic structure as described below with reference to FIGS. 20-22. Also, although reference is made throughout this document to the screen being constructed from individual elongate elements, the examples provided may also use a screen that is constructed as a perforated object. For example, a sheet material such as a sheet of steel may be perforated and formed to construct the screen. Also, a screen could be moulded from a plastics material, the mould providing the required perforations in the resultant screen object. The perforations may be in the form of elongate slots but could also conform to other shapes.

A hanger bracket 9 is provided from which a transition funnel 10 is provided. The funnel 10 is generally in the form of a frustum of a cone, but it will be seen that other shapes could be used according to the present invention. The transition funnel 10 provides an effective way of accumulating screenings and reducing then by squeezing out liquid for example. The larger end of the transition funnel 10 is open to the upper end of the travel of the rake assembly. The smaller diameter end of the transition funnel 10 is connected to the discharge pipe 11. The rake assembly is driven by a hydraulic shaft 12, which has a piston or otherwise co-operates with a double acting hydraulic cylinder 13 whereby, fluid is provided to and/or from hydraulic or pneumatic circuits to cylinder 13 to create movement of the shaft 12 relative to the cylinder and thereby move the rake in a periodic reciprocating motion up and down the length of guide rail 1. The rake and screen 25 assembly are supported by a support arrangement Generally referenced 14.

The power cylinder 13 may be powered by any suitable available medium, for example hydraulic, pneumatic, or steam. The cylinder is arranged to move the shaft to translate the rake cyclically to the top and then back to the base of the screen. Shoes or linings, such as plastic linings in guide 5 (not shown for clarity) assist in reducing friction between the stationary and moveable assemblies.

The cylinder 13 is double acting, or there are two cylinders, or there is an appropriate mechanical arrangement associated with a single cylinder to achieve the desired result of a reciprocating cyclical rake action. Furthermore, the required control apparatus for activating the cylinder is provided, as is well known to those skilled in the art

As a further alternative, the motive power to drive the shaft 12 could be provided by a motor with a speed reducer operating through a rack and pinion arrangement, or a worm drive arrangement.

The shaft 12 is preferably provided so as to directly drive the rake and to pass through the waste pipe 11 and transition funnel 10. However, it will be seen that other arrangements may be provided without departing from the scope of the invention. In particular, the shaft 12 may be provided above the pipe 11 and transition funnel 10 and have a further arm or a bend that connects the shaft 12 to the rake 3. Also, the rake 3 may be driven indirectly by another mechanical arrangement if desired.

Referring now to FIG. 1a, optionally, a screw conveyor 101 can be incorporated into the existing design for picking up the screenings from the upper end of the rake assembly within the transition funnel 10 and transporting them to the end of the waste pipe 11 or any other selected location where the screenings are discarded. Typically these screenings would most likely originate from a sewerage discharge or from an industrial discharge. The helical flight of screw 105 is mounted around a worm conveyor shaft 104, which is a hollow shaft driven be a shaft mounted speed reducer 106. The speed reducer 106 is provided to drive the helical screw at different speeds depending on the nature of the screenings or the work rate (i.e. cycle speed) of The rake. The shaft 12, which powers the rake assembly passes right through the entire length of the worm conveyor shaft 104. The main function of the screw conveyor 101, which operates in concert with the rake system, is to move the screenings through the transition funnel (where some compression of the screenings occurs) and through the discharge pipe 11 for disposal.

Alternatively, the transition funnel 10 and waste pipe 11 can be excluded from the design. In the absence or the screw conveyor, the screenings build up in the funnel 10 under the action of the rake on the rake upstroke and the rake action moves the screenings through the discharge pipe 11 and into the bin 11a. As a result, the screenings are discharged from the upper end of the discharge pipe 11 directly underneath which a bin 11a is provided to collect the discharge.

Turning now to FIG. 2, some further information is provided in this partial plan view of the apparatus. It can be seen that two guide rails 1 are clearly provided and the transition funnel is mounted at two hanger bracket supports 9.

Turning to FIGS. 3 and 4, it will be seen that the screen 25 is part circular in this example and the rake assembly is correspondingly part circular having tines or teeth 3a which radiate from the periphery of the rake disk and interdigitate with the longitudinal screen elements 7 of the screen 25. In FIGS. 3 and 4 the element support 15 and brace 16 for holding the rake disk relative to the guide members 1 is shown.

The longitudinal screen elements 7 may be a number of different shapes or cross-sections and some of these are illustrated in FIGS. 5A to 5D, the preferred shape being that shown in FIG. 5B. As can be seen from the partial cross-section of FIG. 3, the longitudinal screen elements 7 having the cross-section according to FIG. 5B are organised with the short leg of the “L” being approximately 80° relative to the centre piece, and facing upwardly or inwardly toward the rake disk. In FIG. 5A the profile has a vertical section with a smaller section at right angles intersected at the centre. This alternative is referred to as a “piece”.

In FIG. 5C the element has an end piece with sloping shoulders. This alternative is referred to as a “Y wire”.

In FIG. 5D the element has a gradual taper from top edge to the lower edge.

The operation of the apparatus will now be described. The apparatus is arranged so that a flow of waste liquid or water which includes a suspension of solid matter (which may include floating solid matter) is delivered, as illustrated by arrow 17 in FIG. 1, so that the liquid flow is through the gaps between longitudinal screen elements 7. The inlet 26 flow area to the screen 25 is preferably approximately 33% of the total area of screen 25. It will be seen that the screen 25 is advantageously arranged so as to assist capture of solids in the liquid flow. That is to say, the screen 25 is in the form of a trough, being substantially “concave” having a centre portion which when viewed in cross-section is somewhat lower than the side portions of the screen 25. This general shape may be curved as illustrated in the preferred embodiment of FIG. 1, but will be seen that other shapes may accommodate the same purpose, for example a screen 25, shape which is substantially rectangular in cross-section either having vertical or angled or curved sides, or a screen 25 shape which simply has angled sides or is triangular or “V” shaped in cross-section. All of these shapes which have sides of some sort to the screen 25 substantially prevent any solids from escaping from the sides of the screen 25 and also generally assist the raking process by tending to have solids collect in the centre of the screen 25 under gravity as the rake moves. The screen shapes described above also have the advantage that a larger screen area is provided in a reduced lateral space.

As illustrated in FIG. 1, as the rake moves upwardly in the direction of arrow 18 following actuation of the cylinder 13, the rake tines or teeth 3a scrape, rake or otherwise capture or move solid matter up the screen 25 towards the upward delivery end of the screen 25 where the solids are deposited in the transition funnel 10. Upon reaching the upper limit of the screen 25, the rake returns down the screen 25 to the lower position. In the preferred embodiment, the rake travels up the screen 25 more slowly than it travels in the reverse direction toward the bottom. Preferably, the rake travels down the screen 25 at approximately ⅓ the time it takes to travel up the screen 25. The cycle time of the rake can be varied by the control system dependent on the flow rate through the screen and/or the solids content of the through flow. By way of example a typical time period for the upstroke may be 20 seconds, and the downstroke 7 seconds.

Any solid matter which is captured on the screen 25 while the rake is at the upper end of the screen 25 is brushed off the screen 25 by the rake with its relatively quick downward movement. Usually, matter which is moved by the rake with the downward movement will simply resurface from the liquid flow to be again deposited in the centre of the screen 25 and therefore be collected by the rake on its upward stroke. However, if the solid matter in the liquid flow is such that it tends not to be re-supplied to the screen 25 upon the downward stroke or the rake, other means may be used to dislodge the solid matter from the base of the screen 25 so that it may be returned to the liquid flow to be deposited again above the rake. For example, an appropriate mechanism for returning such solids in this manner may be bubbling air or other gas or directing an appropriate flow of liquid around the base of the screen 25 elements to force a general upward flow of any solids back into the water streams. It will be seen that other devices or methods could be used. For example, a plate or baffle (not shown) may be provided attached to the bottom of the rake and extending generally upwardly from the rake so as to assist dislodgement of solids from the screen on the downstroke, and assist collection of solids on the upstroke. The plate or baffle may be hingedly attached to the rake (as described further below) so that it folds flat on the downstroke and returns to a substantially upright position on the upstroke.

Once the solids have been pushed up to the transition funnel 10, they will over time accumulate and become compressed by the transition funnel after being pushed by farther solid matter which is dragged into the transition tunnel by the rake. Therefore, over time, the general form of the transition funnel, being a shape which reduces in cross-sectional area, will tend to compress the collected screenings and force them into a relatively compressed or compacted state into the discharge pipe 11. The screenings will continue to move through the discharge pipe 11 around the arm 12, before being deposited from the end of the discharge pipe 11 into the waste bin. The general movement of screenings through the discharge pipe 11 is illustrated by arrow 19.

### EXAMPLE 2

Turning now to FIG. 6, a further embodiment of the invention is illustrated. The overall apparatus is substantially the same as that described with reference to the preceding figures. Also, the reference numerals in the embodiment shown in FIG. 6 which are the same as reference numerals used in the preceding figures designate the same or substantially similar features of both embodiments.

The apparatus of FIG. 6 mainly differs form the embodiment described above insofar as an improved arrangement for sweeping screenings off the screen 25 on the downward smoke is provided. This further apparatus generally comprises a baffle member 22 and a specially angled lower edge 23 on the reverse side of the rake. The angled lower edge 23 assists with dislodging solid matter trapped on the screen during the downstroke of the rake, so that the solid matter may be forced back in the liquid flow and thus captured on the next upstroke as shown by arrows 20 and 17. A further aspect which may be provided in the embodiment shown in FIG. 6 is an improvement to the collection, accumulation and compression aspect of the invention through the transition funnel 10 and the discharge pipe 11.

The baffle member 22 is provided hingedly dependent from the bottom of the rake, preferably, adjacent to the disc guides 5 of the rake. The baffle 22 is preferably shaped so as to be substantially the same shape as the rake (in the present example being substantially disk shaped). The baffle member 22 is also allowed to simply “float” but is preferably counter balanced, so as to remain in a position as illustrated in FIG. 6 when the rake is traversing its downward stroke. When the rake moves through its upward stroke, the baffle member 22 moves into a position where it lies flat against the rake tines 50 as to assist transport of solid matter collected off the screen 25 by the Take towards the top end of the screen 2. In this way, the baffle member 22 assists in transporting solid matter up the screen 25 and it also assists in delivering solid matter into the transition funnel 10. It will be seen that the lower front edge of the rake is also angled and this further assists in collecting screenings from the screen 25 surface, particularly any solid matter, which becomes wedged between the longitudinal screen 25 elements,

On the downward stroke, with the baffle member 22 in position shown in FIG. 6, the angled edge 23 of the lower edge of the rake lifts the solid matter collected on the screen 25 while the rake has been at the upper end of the screen 25. The solids lifted by the reverse side of the rake will mainly be returned into a part of the screen 25 above the rake by means of the flow of liquid across the screen 25. This is illustrated by arrow 21 in FIG. 6. Alternatively, solids which are too large in size to move through the rake and back onto the screen 25, will be transported by the rake down to the base of the screen 25 so that they are returned to the flow of liquid into the screen 25 above the rake. This path of travel is indicated by arrow 20 in FIG. 6. Therefore, it will be seen that an effective and simple way of ensuring that solids which accumulate on the screen 25 while the rake is near the top of the screen 25 are returned to the main flow path.

Referring now to the shaft 12, it will be seen that a member 30 is provided about shaft 12 in the vicinity of transition funnel 10. This member 30 is generally cone shaped, but it will be seen that other shapes may be provided. The purpose of this member 30 is to ensure that continued travel of the screenings compressed by the transition funnel 10 is facilitated through to the outlet tube 11. Therefore, the substantially perpendicular top face of the cone 30 provides a relatively flat surface against which screenings are moved upwardly. The front surface is angled so as not to encourage flow of screenings back towards the screen 25. Also, a compression member comprising a further baffle 32 which is preferably sprung or otherwise tensioned or biased toward the end of outward pipe 11 can assist to ensure that the screenings are further compressed before they are released into the bin 11a.

### EXAMPLE 3

The following example should be regarded as the most preferred embodiment of the invention.

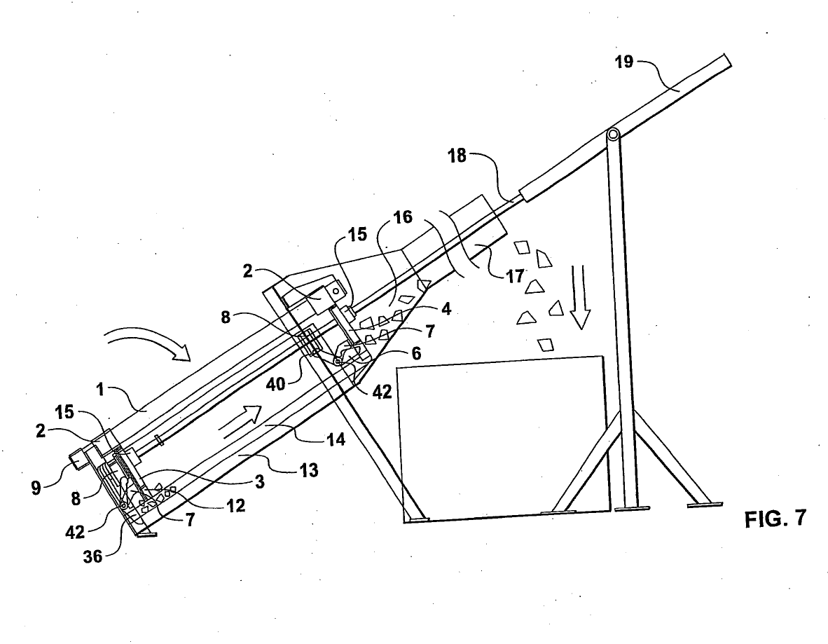

Turning now to FIG. 7, a further side elevation of the apparatus generally described in the preceding figures is shown with the addition of a mechanism for extending and retracting the rake teeth. The reference numerals used on the embodiment shown in FIG. 7 that are the same as reference numerals in the embodiments described above depict the same or substantially similar features.

The main difference with the rake assembly of the embodiment shown in FIG. 7 is that the rake has a guide block 38 which receives one end of each rake tooth 40. The other end 36 of each the rake tooth is the operative part of the rake i.e. the part which actually moves solids along the screen. As will be seen, between ends 36 and 40 of each rake tooth, the tooth is pivoted at a point 42. Therefore, when the drive shaft 18 is moved relative to the remainder of the rake assembly (i.e, when the rake changes direction for example) the driving block 38 will move a short distance relative to the rest of the rake assembly because of the friction of the rake assembly on the screen.

As shown in FIG. 7, when the rake has reached the top of the screen and the drive shaft 18 move in a direction back down the screen, driving block 38 will be moved relative to the remainder of the rake and will lift the teeth 36 so that they are in a position substantially parallel to the screen as shown at the upper end of the screen in FIG. 7.

Conversely, at the lower end of the screen, as shaft 18 begins to move in an upward direction to drag the rake up along the screen, the driving block 38 will move upwardly relative to the remainder of the rake assembly which will pivot the teeth 36 downwardly so that they interdigitate with the screen elements ready to drag solids along the screen to the upper end of the screen.

With this arrangement, it will be seen that the rake can be effectively retracted on the downward stroke so that solids are not dragged back down the screen, but are only moved up the screen in one direction toward the outlet for delivery to the bin.

Turning now to FIG. 8, a plan view of the lower end of the screen is shown, again with the rake teeth 36 in a position which they are extended ready to drag solids up the screen.

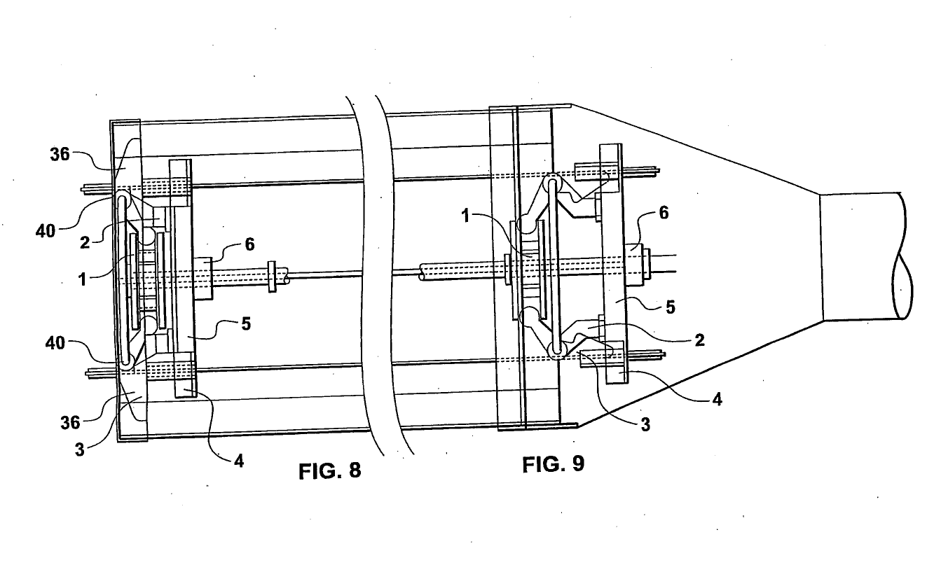

Turning to FIG. 9, a plan view of the upper end of the screen is shown, corresponding to the position of the rake at the upper end of the screen in FIG. 7. The teeth are shown in the retracted position.

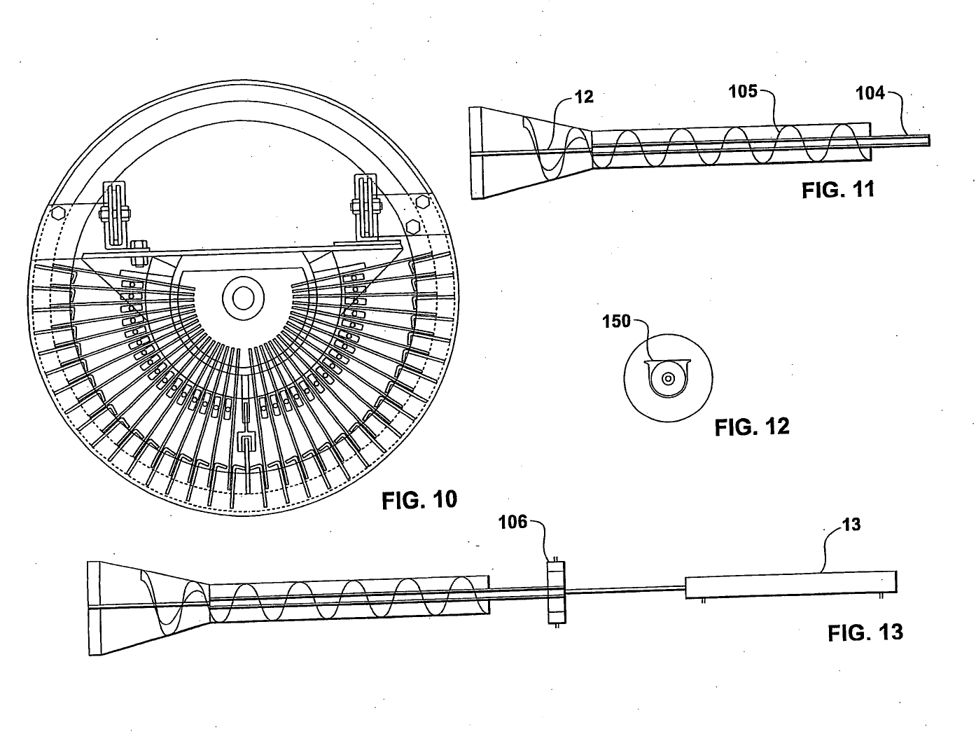

Referring now to FIG. 10, the general arrangement of rake teeth in the semi circular screen arrangement is illustrated.

Referring now to FIG. 11, a screw or worm 105 having a helical flight is mounted around a worm conveyor shaft 104 as described with reference to FIG. 1A. The only difference with this construction is that the waste pipe 11 instead comprises a trough 150. In FIG. 13, the screw drive 106 and hydraulic cylinder 13 are shown.

Turning now to FIG. 14 a further example of the present invention is illustrated. In this example, a plough 160 is also provided dependent from the shaft 12. The plough 160 is shown in FIG. 14 in a lower position and in its uppermost, extended, position. As can be seen from the extended position plough placement in which it is within the transition funnel 10, the plough facilitates movement of screenings within the transition funnel 10 towards the waste pipe 11 every time the main shaft 12 nears the upper limit of its extension. Therefore, every time the rake moves near the top of the screen, the plough provides a pushing action to push screenings through the transition funnel 10 and into the discharge pipe 11. FIG. 14 also shows that a support bearing 162 is provided for shaft 12. This bearing provides support for the shaft 12 which may be required in response to loads imposed on the plough 160 by accumulated screenings in the transition funnel 10 and/or waste pipe 11.

Also, to further encourage movement of screenings through waste pipe 11, a wedge 164 is provided on shaft 12. The wedge is generally conical in form, or may be described as a frustom of a cone. The wedges outer surfaces are angled so that at minimal driving action is imposed on screenings in the waste pipe 11 when the wedge is travelling in a downward direction. However, in the other direction, the wedge has an abrupt surface which is perpendicular to the movement of the wedge. This facilitates movement of screenings through discharge pipe 11. Therefore, when the rake is travelling down toward the base of the screen, screenings which are in the waste pipe 11 are unlikely to be significantly moved down the discharge pipe. However, when the rake is traveling towards the top of the screen, the wedge tends to move screenings within the discharge pipe, up, along the pipe.

In FIG. 15, the wedge is shown in greater detail, and in FIG. 16 the wedge is shown in end elevation from which it can be seen that the wedge is substantially conical in form

In FIG. 17 the plough is shown in side elevation including a mounting aperture 170 to mount the plough relative to the shaft 12.

In FIG. 18, the bearing is shown having an outer case 180 which is substantially rigid, a cover 182 and a central bearing element 184. Cover members 182 and 180 securely hold bearing 184 in place. However, bearing 184 is made from a flexible plastics material, most preferably ultra high molecular weight polyethylene (UHMWPE). The inner surfaces of bearing 184 contact shalt 12, but since the bearing is constructed from a resilient material, the bearing allows movement of the shaft relative to the cover members 180 and 182. In this way, the shaft is supported, but there is still sufficient tolerance and flexibility for the plough member and unit as a whole to function effectively.

The bearing apparatus of FIG. 18 is shown in end elevation in FIG. 19.

As mentioned previously in this document, the screen may alternatively comprise a perforated plastics structure. Such a screen is illustrated in FIGS. 20-22, and may be referred to as a plastic media perforated screen. The screen may be moulded in the required form. Alternatively, the screen may be constructed from a sheet of plastics material which is treated to give it the required overall shape, and machined to provide the required slots and apertures as described further below.

Referring to FIG. 20, the perforated screen 200 is shown in end elevation with partial view of the rake including rake tines or teeth 3a also illustrated. The holes provided in the screen 200 are not shown in FIG. 20, but are shown in FIGS. 21 and 22. In FIG. 20, the longitudinal slots 210 that run the length of the screen are shown. These slots provide a guide for the rake teeth 3a to run along the length of the screen. Therefore, the rake can operate along the screen as described in the embodiments discussed above to push solids clear of the screen. The slots are each preferably approximately 10 mm wide in the most preferred embodiment.

Turning, now to FIG. 21, the screen 200 is shown in plan view and the perforations in the screen are also shown. The perforations take the form of holes 212. These are preferably placed at 10 mm centres over the screen. Furthermore, the holes are preferably tapered. This is shown more clearly in the partial cross-section of FIG. 22. In that view, it can be seen that The holes taper from a larger aperture on the rear side of the screen to a smaller aperture on the front (i.e. the rake side) of the screen. In this way, material which has a dimension that is similar to that of the holes 212 sits on top of the holes rather than passing into the holes and becoming jammed. If any material does just manage to fit through the entrance to one of the holes 212, then the path for that piece of material through the hole becomes progressively easier due to the increasing taper towards the rear of the screen. Therefore, materials are unlikely to get stuck in the holes. If any material is not passed through the holes, then it will be removed by the rake.

The holes 212 are shown in greater detail in FIG. 23. In particular, the taper on the holes can he seen by the difference in size between the entrance aperture 214 and the exit aperture (-line) 216 for each hole.

It will be appreciated that the features referred to in the examples above may be interchanged amongst the various constructions to provide a raking system which best meets the requirements of any particular installation.

It will be seen that the apparatus has the distinct advantage that the screenings are allowed to compress and compact and are delivered automatically to a bin without need of any time consuming compaction or compression operations and without requiring additional mechanical apparatus to male the screenings away from the rake and deposit them in a waste receptacle such as a bin.

In addition the working components of the apparatus are accessible in comparison to the prior art, making it easier to maintain.

It will be appreciated that the invention maybe provided in different embodiments without departing from the spirit or scope of the invention as set forth herein. Where the word “comprises” or variance thereof such as “comprising” are used throughout this document, it will be understood that this word is not being used in a limited sense, but is instead being used in an inclusive sense.

1. Apparatus for the removal of solids from a suspension in which the solids are provided, the apparatus including
a screen having a plurality of apertures therein,
a rake provided on or adjacent to the screen,
driving means to cyclically drive the rake in two opposing directions relative to the screen to move solids captured on the screen toward one end of the screen.

2. Apparatus as claimed in claim 1 wherein the flow of solids from the screen through to discharge is in substantially one direction or axis.

3. Apparatus as claimed in claim 1 wherein the screen comprises a trough.

4. Apparatus as claimed in claim 1 wherein the driving means comprises a single prime mover.

5. Apparatus as claimed in claim 3 wherein the screen is substantially concave.

6. Apparatus as claimed in claim 1 wherein the driving means moves the rake periodically back and forth along the screen.

7. Apparatus as claimed in claim 6 wherein the time taken for the rake to traverse the screen in a direction toward one end is longer than the time taken on the downward stroke is less than the time taken for the rake on the upward stroke.

8. Apparatus as claimed in claim 1 including accumulator means to accumulate the solids, the accumulator means comprising a transition element through which the solids are compressed before reaching an outlet for disposal.

9. Apparatus as claimed in claim 1 wherein the screen is substantially semi circular and extends across an arc of approximately 210° to 260°.

10. Apparatus as claimed in claim 1 wherein the screen elements run longitudinally with slots which are kept clear by a rake positioned and installed having teeth radiating from a disk member. Preferably the slots are greater than or equal to 3 mm.

11. Apparatus as claimed in claim 1 wherein the rake has tines which are capable of being disposed in an operative position and in an inoperative position.

12. Apparatus as claimed in claim 11 wherein the tines are displaced in the operative position when the rake travels in at upward direction, and disposed in the inoperative position when the rake travels in the downward direction.

13. Apparatus as claimed in claim 1 wherein a waste conduit is provided, and the driving means includes a shaft provided through the waste conduit.

14. Apparatus as claimed in claim 13 wherein the shaft includes a wedge to facilitate movement of screenings through the waste conduit.

15. Apparatus as claimed in claim 1 wherein the rake includes a baffle means to facilitate movement of solids toward the one end of the screen.

16. Apparatus as claimed in claim 1 wherein the rake includes a plough means to facilitate movement of solids off the screen.

17. Apparatus for the removal of solids from the suspension in which the solids are provided substantially as herein described.

18. Apparatus for the removal of solids from the suspension in which the solids are provided substantially as herein described with reference to accompanying drawings.

19. Any novel feature or combination of features disclosed herein.
